(19) United States
(12) Patent Application Publication
(10) Pub. No.: US 2006/0246151 A1
(43) Pub. Date: Nov. 2, 2006

(54) Agricultural, horticultural and veterinary compositions

(75) Inventor: Stuart James Anderson, Oxfordshire (GB)

Correspondence Address: WOLF GREENFIELD & SACKS, PC, FEDERAL RESERVE PLAZA, 600 ATLANTIC AVENUE, BOSTON, MA, 02210-2206, US

(73) Assignee: Oxonica Limited, Kidlington, Oxfordshire (GB)

(21) Appl. No.: 10/558,774

(22) PCT Filed: May 21, 2004
(86) PCT No.: PCT/GB04/02191

§ 371 Date: Dec. 1, 2005

(30) Foreign Application Priority Data
Jun. 3, 2003 (GB) 03127032

(51) Int. Cl. A01N 59/16; A01N 25/00

(52) U.S. Cl. 424/617; 424/641; 504/116.1; 977/900

(57) ABSTRACT

A composition suitable for veterinary, agricultural or horticultural use is disclosed which comprises at least one organic veterinarally, agriculturally and/or horticulturally active compound, and titanium dioxide and/or zinc oxide which has been doped with a second element and/or reduced zinc oxide as well as a composition suitable for household use which comprises at least one organic biocide and one of the specified oxides.

The present invention relates to compositions suitable for use in agriculture, horticulture and veterinary medicine.

It is well known that many of the active ingredients of veterinary, agricultural and horticultural compositions such as herbicides and insecticides are adversely affected by UV light. Such organic compounds have a tendency to degrade or decompose under the influence of UV light either to inactive compounds or compounds which have an adverse effect upon the area being treated. As a result it is necessary to store these products in special containers which do not allow the penetration of UV light. Otherwise the shelf life of the product is too short.

It has now surprisingly been found, according to the present invention, that the adverse effects of UV light on such organic compounds can be reduced and/or eliminated by incorporating in the composition titanium dioxide and/or zinc oxide which has been doped with a second element and/or reduced zinc oxide. In other words by incorporating this specific oxide in the formulation it is possible to dispense with the use of special containers and/or extend the life of the product. In addition its presence enables the user to use less of the product.

Accordingly, the present invention provides a composition suitable for veterinary, agricultural or horticultural use which comprises at least one organic veterinarally, agriculturally and/or horticulturally active compound, and titanium dioxide and/or zinc oxide which has been doped with a second element and/or reduced zinc oxide as well as a method for treating a veterinary, agricultural or horticultural species at a locus which comprises treating the locus with such a composition.

While any reduction in the loss of UV absorption is an advantage, it is generally desirable that the presence of the oxide should reduce the rate of UV absorption by an amount of at least a 5%, preferably at least 10%, more preferably at least 15%, especially at least 20% and most preferably at least 40%.

The dopant for the oxide particles is preferably manganese, which is especially preferred, e.g. Mn²⁺ but especially Mn³⁺, vanadium, for example V³⁺ or V⁵⁺, chromium and iron but other metals which can be used include nickel, copper, tin, aluminium, lead, silver, zirconium, zinc, cobalt, gallium, niobium, for example Nb⁵⁺, antimony, for example Sb³⁺, tantalum, for example Ta⁵⁺, strontium, calcium, magnesium, barium, molybdenum, for example Mo³⁺, Mo⁵⁺ or Mo⁶⁺ as well as silicon. Manganese is preferably present as Mn³⁺, cobalt as Co²⁺, tin as Sn⁴⁺ as well as Mn²⁺. These metals can be incorporated singly or in combination of 2 or 3 or more. Further details of these doped oxides can be found in WO99/60994 as well as WO01/40114.

The optimum amount of the second component in the host lattice may be determined by routine experimentation. Amounts as low as 0.1 mole % or less, for example 0.05 mole %, or as high as 1 mole % or above, for example 5 mole % or 10 mole %, can generally be used. Typical concentrations are from 0.5 to 2 mole % by weight.

These particles can be obtained by any one of the standard processes for preparing doped oxides and salts. Thus they can be obtained by a baking technique by combining particles of a host lattice (TiO₂/ZnO) with a second component in the form of a salt such as a chloride or an oxygen-containing anion such as a perchlorate or a nitrate, in solution or suspension, typically in solution in water, and then baking it, typically at a temperature of at least 300° C. Other routes which may be used to prepare the doped materials include a precipitation process of the type described in J. Mat. Sci. (1997) 36, 6001-6008 where solutions of the dopant salt and of an alkoxide of the host metal (Ti/Zn) are mixed, and the mixed solution is then heated to convert the alkoxide to the oxide. Heating is continued until a precipitate of the doped material is obtained. Further details of preparation can be found in the aforesaid patent specifications.

The rutile form of titania is known to be more photostable than the anatase form and is therefore preferred.

Reduced zinc oxide particles (i.e. particles which possess an excess of zinc ions relative to the oxygen ions) may be readily obtained by heating zinc oxide particles in a reducing atmosphere to obtain reduced zinc oxide particles which absorb UV light, especially UV light having a wavelength below 390 nm, and remit in the green, preferably at about 500 nm. It will be understood that the reduced zinc oxide particles will contain reduced zinc oxide consistent with minimising migration to the surface of the particles of electrons and/or positively charged holes such that when said particles are exposed to UV light in an aqueous environment the production of hydroxyl radicals is substantially reduced as discussed above.

The reducing atmosphere can be air with a reduced oxygen content or an increased hydrogen content but is preferably a mixture of hydrogen and an inert gas such as nitrogen or argon. Typically the concentration of hydrogen is from 1 to 20%, especially 5 to 15%, by volume, with the balance inert gas, especially nitrogen. A preferred reducing atmosphere is about 10% hydrogen and about 90% nitrogen by volume. The zinc oxide is heated in this atmosphere at, say, 500° to 1000° C., generally 750 to 850° C., for example about 860° C., for 5 to 60 minutes, generally 10 to 30 minutes. Typically it is heated to about 800° C. for about 20 minutes.

It is believed that the reduced zinc oxide particles possess an excess of Zn²⁺ ions within the absorbing core. These are localised states and as such may exist within the band gap. A further discussion of this can be found in WO 99/60994.

The oxide particles used in the present invention may have an inorganic or organic coating. For example, the particles may be coated with oxides of elements such as aluminium, zirconium or silicon. The particles of metal oxide may also be coated with one or more organic materials such as polyols, amines, alkanolamines, polymeric organic silicon compounds, for example, RSi[{OSi(Me)₂}xOR¹]₃ where R is C₁-C₁₀ alkyl, R¹ is methyl or ethyl and x is an integer of from 4 to 12, hydrophilic polymers such as polyacrylamide, polyacrylic acid, carboxymethyl cellulose and xanthan gum or surfactants such as, for example, TOPO.

The average primary particle size of the particles is generally from about 1 to 200 nm, for example about 1 to 150 nm, preferably from about 1 to 100 nm, more preferably from about 1 to 50 nm and most preferably from about 20 to 50 nm.

Where particles are substantially spherical then particle size will be taken to represent the diameter. However, the invention also encompasses particles which are non-spherical and in such cases the particle size refers to the largest dimension.

The present invention is applicable to any composition intended for agricultural or horticultural use which contains an organic active ingredient as well as to veterinary compositions containing an organic active ingredient, generally for topical application. Generally the active ingredient will be a biocide but it can be, for example, a plant growth promoter or regulator. Thus the compositions of the present invention are typically herbicides, fungicides, insecticides, bactericides, acaricides, molluscicides, miticides or rodenticides, which can be broad spectrum or selective. The present invention is particularly useful for fast knockdown insecticides which are badly affected by UV light. Veterinary compositions can take the form of, for example, antiseptic or wound healing preparations.

The compositions of the present invention can also be formulated for household use as with, for example, insecticides and rodenticides. Accordingly, the present invention also provides a composition suitable for household use which comprises at least one organic biocide and titanium dioxide and/or zinc oxide which has been doped with a second element and/or reduced zinc oxide.

The compositions of the present invention can contain any of the organic active ingredients currently employed for such compositions.

Suitable herbicides which can be used in the present invention include triazines, amides, in particular haloacetanilides, carbamates, toluidines (dinitroanilines), ureas, plant growth hormones, in particular phenoxy acids and diphenyl ethers. Thus herbicides which may be used include phenoxy alkanoic acids, bipyridiniums, benzonitriles with phthalic compounds, dinitroanilines, acid amides, carbamates, thiocarbamates, heterocyclic nitrogen compounds including triazines, pyridines, pyridazinones, sulfonylureas, imidazoles and substituted ureas as well as halogenated aliphatic carboxylic acids, some inorganic and organic materials and derivatives of biologically important amino acids. Specific herbicides which can be used in the present invention include 2,4-dichlorophenoxyacetic acid (2,4-D) and 2,4,5-trichlorophenoxyacetic acid (2,4,5-T). Suitable triazines include 2-chloro-, 2-methylthio-,2-methoxy-4,6-bis-(alkylamino)-s-triazines as well as some 2-azido-substituted triazines. Typical herbicidal ureas include monuron (3-p-chlorophenyl) 1,1-dimethylurea) as well as diuron, neburon, fenuron and chloroxuron. Suitable carbamates include N-phenylcarbamate and isopropyl carbanilate (propham) and substituted derivatives thereof including isopropyl m-chlorocarbanilate (chlorpropham) as well as barban, swep, dichlormate and terbutol. Suitable thiocarbamates include EPTC, metham, vernolate, CDEC, pebulate, diallate, triallate, butylate, molinate, cycloate, thiobencarb and ethiolate. Suitable amide herbicides include solan, dicryl, propanil, dipehamid, propachlor, alachlor, CDAA, naptalam, butachlor, prynachlor and napropamide. Suitable chlorinated aliphatic acids include triochloroacetic acid (TCA), dalapon and 2,2,3-trichloropropionic acid. Suitable chlorinated benzoic acids include chloramben, DCPA, dicamba, dichlobenil and 2,3,6-TBA. Phenolic herbicides which can be used include bromoxynil, ioxynil, DNOC and dinoseb. Suitable dinitroanilines which can be used inlclude benefin, trifluralin, nitralin, oryzalin, isopropalin, dinitramine, fluchloralin, profluralin and butralin. Suitable bypyridinium herbicides include diquat and paraquat salts and derivatives thereof.

Suitable insecticides which can be used in the present invention include nicotinoids, rotenoids, derivatives of the seeds of sabadilla and the plant ryania speciosa and pyrethroids as well as organochlorine insecticides, organophosphorus insecticides, carbamate insecticides and various insect growth regulators.

Suitable nicotinoids include nicotine sulfate and imidocloprid. The pyrethroids constitute a large group of insecticides most of which are now synthetic including resmethrin, phenothrin, cyphenothrin, empenthrin, prallethrin, permethrin, cypermethrin, alpha cypermethrin, tetramethrin and delta tetramethrin, including their isomers, especially optical isomers along with derivatives of these. Suitable organochlorine insecticides include DDT (dichlorodiphenyltrichloroethane) along with methoxychlor and perthane, as well as lindane, toxaphene, chlordane, heptachlor, aldrin, dieldrin and endrin. Suitable organophosphorus insecticides include phosphoric acid and phosphorothioic acid anhydrides, aliphatic phosphorothioate esters along with phenyl phosphorothioate esters, phenyl phosphorodithioate esters, phosphonothioate esters of phenols, vinyl phosphates, phosphorothioate esters of heterocyclic enols and of s-methyl heterocycles. Of these specific mention can be made of parathion, methyl parathion, dicapthon, chlorthion, fenitrothion, fenthion and fensulfothion along with fenchlorphos, cyanophos, propafos and temephos. Suitable carbamate insecticides which can be used include carbaryl, carbofuran, propoxur, dioxacarb, bendiocarb, mexacarbate, isoprocarb and ethiofencarb. Suitable acaricides include chlorfenethol, chlorobenzilate, dicofol, tetradifon, sulphenone, ovex, propargite, cyhexatin and dienochlor.

Some of the insecticides given above are suitable for killing rodents but other rodenticides which can be used include acute rodenticides and chronic poisons include anticoagulants; these can be stomach poisons, contact poisons or fumigants. Such anticoagulants include dicoumarol, warfarin, coumatetraly, coumachlor, difenacoum, brodifacoum, bromadiolone, pindone, diphacinone and chlorophacinone.

Insecticides which can be used in the compositions of the present invention can also be in the form of microbial agents since insects are attacked by many pathogens. These include bacterial agents, in particular bacillus microorganisms, especially bacillus thuringiensis (b.t.) strains such as b.t. aizawa, israelensis, kurstaki and tenebrionis, fungal agents, protozoa and viruses.

Suitable fungicides which can be used in the compositions of the present invention include elements such as sulphur, copper, mercury and tin along with thiocarbamate and thiurame derivatives, phthalimides and trichloromethylthiocarboximides, aromatic hydrocarbons and dicarboximides. Specific examples include ferbam, ziram, thiram, zineb, maneb and mancozeb as well as dimethylthiocarbamates and ethylene bis-dithiocarbamates. Other useful fungisides include captan, folpet, captafol and dichlofluanid. Suitable aromatic hydrocarbons include quintozene, dinocap, chloroneb, dichloran, dichlone and chlorothalonil along with oxazolidinediones such as vinclozolin, chlozolinate, hydantoin such as iprodione and succinimide such as procymidone. Other fungicides which can be used include guanidine salts such as dodine, quinones such as dithianon, quinoxalines such as chinomethionat, pyridazines such as diclomezine, thiadiazoles such as etridiazole, pyrroles such as fenpiclonil, quinolines such as ethoxyquin and triazines such as anilazine. Other fungicides which can be used include mitochondrial respiration inhibitors which are generally carboxanilides including carbox, oxycarboxin, flutolanil, fenfurmn, mepronil, methfuroxam and metsulfovax. Further fimgicides which can be used include microtubuline polymerization inhibitors including thiabendazole, fuberidazole, carbendazim, benomyl and thiophanate methyl. Other suitable fungicides include inhibitors of sterol biosynthesis including C-14 demethylation inhibitors such as triazoles which have a 1,2,4-triazole group attached through the 1-nitrogen to a large lipophilic group, in particular triadimefon, propiconazole, tebuconazole, cyproconazole and tetraconazole along with flusilazole which incorporates a silicon atom, myclobutanil, flutriafol and imibenconazole. Other fungicides which can be used include RNA biosynthesis inhibitors, phospholipid biosynthesis inhibitors, melanin biosynthesis inhibitors, fungal protein biosynthesis inhibitors and cell wall biosynthesis inhibitors.

The compositions of the present invention can be in liquid or solid form. Liquid compositions can be aqueous or non aqueous while solid forms include powders or dusts, granules and tablets. For rodenticides, in particular, the compositions can take the form of a bait, especially a foodstuff, for example grain, which has been treated with the rodenticide and the special oxide.

The concentration of the active ingredient in the composition can vary within a wide range but is typically 0.5 to 95, for example 1 to 50, % by weight.

A composition according to the invention preferably contains from 0.5% to 95% by weight (w/w) of active ingredient.

The compositions for agricultural or horticultural use according to the invention generally contain a carrier to facilitate application to the locus to be treated, which may for example be a plant, seed or soil, or to facilitate storage, transport or handling. The carrier may be a solid, or a liquid, as well as material which is normally a gas but which has been compressed to form a liquid.

The compositions may be in the form of, for example, emulsion concentrates, solutions, oil in water emulsions, wettable powders, soluble powders, suspension concentrates, dusts, granules, water dispersible granules, micro-capsules and gels. Other substances, such as fillers, solvents, solid carriers, surface active compounds (surfactants), and optionally solid and/or liquid auxiliaries and/or adjuvants can be present. The composition can be formulated for dispersing by, for example, spraying, atomizing, dispersing or pouring.

Solvents which may be used include aromatic hydrocarbons, e.g. substituted naphthylenes, phthalic acid esters such as dibutyl or dioctyl phthalate, aliphatic hydrocarbons, e.g. cyclohexane or paraffins, alcohols and glycols as well as their ethers and esters, e.g. ethanol, ethyleneglycol mono- and dimethyl ether, ketones such as cyclohexanone, strongly polar solvents such as N-methyl-2-pyrrolidone or γ-butyrolactone, higher alkyl pyrrolidones, e.g. n-octylpyrrolidone or cyclohexylpyrrolidone, epoxidized plant oil esters, e.g. methylated coconut or soybean oil ester and water. Mixtures can also be used.

Solid carriers, which may be used for dusts, wettable powders, water dispersible granules, or granules, include mineral fillers, such as silicas, calcite, talc, kaolin, montmorillonite or attapulgite. The physical properties may be improved by addition of highly dispersed silica gel or polymers. Carriers for granules may be porous material, e.g. pumice, kaolin, sepiolite, bentonite; non-sorptive carriers may be calcite or sand.

The compositions can be formulated as concentrates which can subsequently be diluted by the user before application. The presence of small amounts of a carrier which is a surfactant facilitates this process of dilution. Thus, preferably the compositions according to the invention preferably contain a surfactant. For example, the composition may contain two or more carriers, at least one of which is a surfactant. Such surfactants may be nonionic, anionic, cationic or zwitterionic.

The compositions of the invention may for example be formulated as wettable powders, water dispersible granules, dusts, granules, solutions, emulsifiable concentrates, emulsions, suspension concentrates and aerosols. Wettable powders usually contain 5 to 90% w/w of active ingredient and 3 to 10% w/w of dispersing and/or wetting agent and, where desirable, 0 to 10% w/w of stabilizer(s) and/or other additives such as penetrants or stickers. Dusts are usually formulated as a dust concentrate having a similar composition to that of a wettable powder but without a dispersant. Water dispersible granules are usually prepared to have a size from 0.15 mm to 2.0 mm and contain 0.5 to 90% w/w active ingredient and 0 to 20% w/w of additives such as stabilizers, surfactants, slow release modifiers and binding agents. Emulsifiable concentrates usually contain, in addition to a solvent or a mixture of solvents, 1 to 80% w/v active ingredient, 2 to 20% w/v emulsifiers and 0 to 20% w/v of other additives such as stabilizers, penetrants and corrosion inhibitors. Suspension concentrates usually contain 5 to 75% w/v active ingredient, 0.5 to 15% w/v of dispersing agents, 0.1 to 10% w/v of suspending agents such as protective colloids and thixotropic agents, 0 to 10% w/v of other additives such as defoamers, corrosion inhibitors, stabilizers, penetrants and stickers, and water or an organic liquid in which the active ingredient is substantially insoluble; certain organic solids or inorganic salts may be present dissolved in the formulation to assist in preventing sedimentation and crystallization or as antifreeze agents for water.

1. A composition suitable for veterinary, agricultural or horticultural use which comprises at least one organic veterinarally, agriculturally and/or horticulturally active compound, and titanium dioxide and/or zinc oxide which has been doped with a second element and/or reduced zinc oxide.

2. A composition suitable for household use which comprises at least one organic biocide, and titanium dioxide and/or zinc oxide which has been doped with a second element and/or reduced zinc oxide.

3. A composition according to claim 1 or 2 wherein the dopant is manganese, vanadium, chromium or iron.

4. A composition according to claim 3 wherein the dopant is Mn³⁺.

5. A composition according to claim 1 or 2 wherein the dopant is present in an amount from 0.05% to 10 mole %.

6. A composition according to claim 5 wherein the dopant is present in an amount from 0.5 to 2 mole % by weight.

7. A composition according to claim 1 or 2 which comprises doped titanium dioxide.

8. A composition according to claim 1 or 2 wherein the titanium dioxide is in rutile form.

9. A composition according to claim 1 or 2 which contains reduced zinc oxide.

10. A composition according to claim 1 or 2 which comprises 0.5 to 20 mole % by weight of the oxide.

11. A composition according to claim 1 or 2 wherein the oxide has a particle size from 1 to 200 nm.

12. A composition according to claim 1 or 2 wherein the active compound is a herbicide, fungicide, insecticide, acaricide, miticide or rodenticide.

13. A composition according to claim 12 wherein the active compound is an insecticide.

14. A composition according to claim 1 or 2 which contains one or more of a filler, organic solvent or surfactant.

15. A composition according to claim 1 or 2 which is in the form of an aqueous or non-aqueous liquid, a powder, granules or tablet.

16. (canceled)

17. A method to reduce the concentration of one or more veterinarally, agriculturally and/or horticulturally active compounds in a composition suitable for veterinary, agricultural, horticultural or household use comprising incorporating into the composition a doped TiO₂/ZnO and/or reduced zinc oxide as defined in claim 1 or 2.

18. A method to increase the shelf life of one or more veterinarally, agriculturally and/or horticulturally active compounds in a composition suitable for veterinary, agricultural, horticultural or household use comprising incorporating into the composition a doped TiO₂/ZnO and/or reduced zinc oxide as defined in claim 1 or 2.

19. A method of increasing the effectiveness of a composition suitable for veterinary, agricultural, horticultural or household use which comprises one or more organic veterinarally, agriculturally or horticulturally or household active compounds, which comprises incorporating into the composition a doped TiO₂/ZnO and/or reduced zinc oxide as defined in claim 1 or 2.

20. A method for treating an agricultural or horticultural species at a locus which comprises treating the locus with a composition as claimed in claim 1.
